(19) United States
(12) Patent Application Publication
(10) Pub. No.: US 2026/0046809 A1
(43) Pub. Date: Feb. 12, 2026

(54) SIDELINK POSITIONING IN PARTIAL COVERAGE

(71) Applicant: Apple Inc., Cupertino, CA (US)

(72) Inventors: Alexander Sirotkin, Hod Hasharon (IL); Amith Chincholi, Sunnyvale, CA (US); Chunxuan Ye, San Diego, CA (US); Fangli Xu, Beijing (CN); Haijing Hu, Los Gatos, CA (US); Jie Cui, San Jose, CA (US); Oghenekome Oteri, San Diego, CA (US); Yuqin Chen, Beijing (CN); Zhibin Wu, Los Altos, CA (US)

(21) Appl. No.: 19/099,590

(22) PCT Filed: Jul. 28, 2023
(86) PCT No.: PCT/US2023/028990

§ 371 Date: Jan. 29, 2025

Related U.S. Application Data
(60) Provisional application No. 63/395,326, filed on Aug. 4, 2022.

(51) Int. Cl. H04W 64/00; H04W 72/25

(52) U.S. Cl. CPC H04W 64/00; H04W 72/25

(57) ABSTRACT

Disclosed are methods, systems, and computer-readable media to perform operations including: receiving, from a second UE via a sidelink channel, a sidelink positioning reference signal (SL-PRS); performing a measurement on the SL-PRS to determine a measurement value of the SL PRS; and transmitting, to the second UE via the sidelink interface, the measurement value in a positioning protocol message, the positioning protocol message to be forwarded to a Location Management Function (LMF) of the wireless communication system.

### CROSS-REFERENCE TO RELATED APPLICATIONS

The present application claims priority to U.S. Prov. App. No. 63/395,326, filed on Aug. 4, 2022, entitled “SIDELINK POSITIONING IN PARTIAL COVERAGE,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have expanded network coverage by using user equipment (UEs) as relays. In particular, the relay UEs establish direct connections with other UEs in order to extent the network coverage to those UEs. The connection that a relay UE establishes with other UEs is referred to as a sidelink communication. Among other examples, the sidelink connection can be either a UE-to-network relay, where the relay UE connects a remote UE to the network, or a UE-to-UE relay, where the relay UE connects a first remote UE to a second remote UE.

### SUMMARY

This disclosure describes systems and methods for sidelink positioning. The systems and methods can be applied in scenarios where a relay user equipment (UE) serves as a relay for a remote UE to a base station of a wireless communication system. The relay UE can be in-coverage of the base station, and the remote UE can be in-coverage or out-of-coverage of the base station. In one example, the relay UE is stationary, knows its absolute geographic coordinates, and is capable of transmitting sidelink positioning reference signals (SL-PRS). In this example, the relay UE can function as a sidelink relay that relays positioning messages between the base station and the remote UE. This functionality enables the wireless communication system to position the remote UE, even if the remote UE is out-of-coverage. In order to implement this arrangement without altering the existing architecture of the core network, the wireless communication system models the relay UE as a transmission/reception point (TRP) of the base station (that serves the relay UE). In particular, the base station presents the relay UE to a Location Management Function (LMF) as a TRP under the base station's control. Under this arrangement, the base station can relay positioning messages (e.g., to obtain a sidelink PRS configuration) between the LMF and the remote UE.

In one aspect, a method to be performed by a first UE is disclosed. The method involves receiving, from a second UE via a sidelink channel, a sidelink positioning reference signal (SL-PRS); performing a measurement on the SL-PRS to determine a measurement value of the SL-PRS; and transmitting, to the second UE via the sidelink interface, the measurement value in a positioning protocol message, the positioning protocol message to be forwarded to a Location Management Function (LMF) of the wireless communication system.

The foregoing and other implementations can each, optionally, include one or more of the following features, alone or in combination.

In some implementations, the method further involves: receiving, from the second UE via the sidelink channel, assistance information including configuration information of the SL-PRS.

In some implementations, the positioning protocol message is a first positioning protocol message, and the assistance information is received in a second positioning protocol message from the LMF.

In some implementations, the assistance information further includes geographical coordinates of the second UE.

In some implementations, the second UE is served by a base station, and the assistance information further includes configuration information of positioning reference signals transmitted by the base station.

In some implementations, the method further involves: receiving, from the second UE via the sidelink channel, a request for location information of the first UE.

In some implementations, the positioning protocol message is a first positioning protocol message, and the request for location information is received in a second positioning protocol message from the LMF.

In some implementations, the SL-PRS is a downlink SL-PRS, and the method further involves: transmitting, via the sidelink channel, an uplink SL-PRS to the second UE.

In some implementations, the second UE is assigned a transmission/reception point (TRP) type.

In some implementations, the positioning protocol is a Long Term Evolution (LTE) positioning protocol (LPP).

In another aspect, a method to be performed by a core network device in a wireless communication system is disclosed. The method involves sending, to a base station of the wireless communication system, a request for positioning reference signal (PRS) configurations from one or more transmission/reception points (TRPs) controlled by the base station, where the request includes a first TRP type for user equipment (UEs) capable of transmitting sidelink-PRS (SL-PRS); and receiving, from the base station, a response message including the PRS configurations, where the PRS configurations include an SL-PRS configuration from a relay UE that is served by the base station and that is associated with the first TRP type.

The foregoing and other implementations can each, optionally, include one or more of the following features, alone or in combination.

In some implementations, the request and the response message are positioning protocol signaling.

In some implementations, the method further involves: generating a message to provide assistance data to a remote UE coupled to the relay UE via a sidelink channel, where the assistance data includes at least the SL-PRS configuration.

In some implementations, the assistance information further includes geographical coordinates of the relay UE.

In some implementations, the method further involves: generating a request for location information to be transmitted to a remote UE coupled to the relay UE via a sidelink channel.

In some implementations, the method further involves: receiving, from the remote UE, the location information of the remote UE, where the location information includes a measurement of the SL-PRS.

In some implementations, the SL-PRS is downlink SL-PRS, and the method further involves: sending instructions to the relay UE to receive uplink SL-PRS from the remote UE; and receiving, from the relay UE, a measurement of the uplink SL-PRS.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates positioning architecture in a wireless communication network, according to some implementations.

FIG. 2 illustrates an example wireless network, according to some implementations.

FIG. 3 illustrates an example of a relay user equipment (UE) integrated with the positioning architecture of FIG. 1, according to some implementations.

FIG. 4 illustrates example positioning protocols used in sidelink positioning, according to some implementations.

FIG. 5 illustrates an example communication flow for sidelink positioning, according to some implementations.

FIG. 6 illustrates example uplink sidelink positioning workflows, according to some embodiments.

FIGS. 7A and 7B illustrate example methods, according to some implementations.

FIG. 8 illustrates a user equipment (UE), according to some implementations.

FIG. 9 illustrates an access node, according to some implementations.

FIG. 10 illustrates a block diagram illustrating components, able to read instructions from a machine-readable or computer-readable medium, according to some implementations

Like reference numbers and designations in the various drawings indicate like elements.

### DETAILED DESCRIPTION

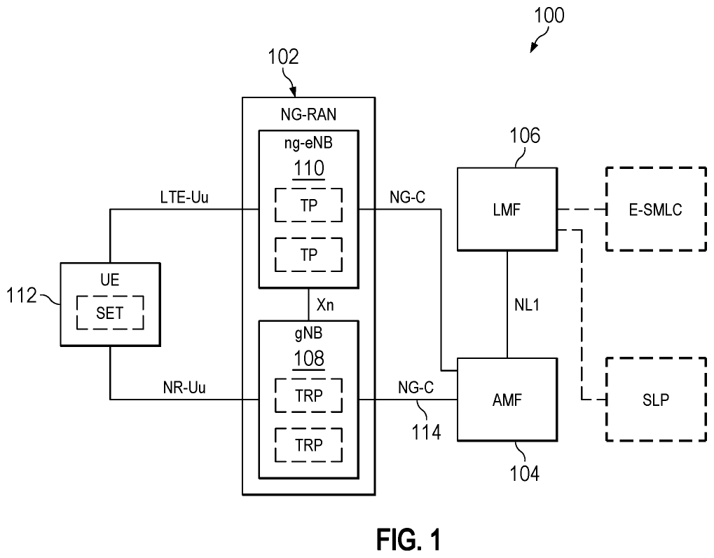

For various reasons, such as navigation, direction finding, Internet service, and location-based digital services, it is helpful for a wireless communication system to determine the location of user equipment (UEs) served by the system. To this end, Release 16 (Rel-16) of the Third Generation Partnership Project (3GPP) telecommunication standards introduced a positioning architecture that improves the positioning of UEs. This architecture is described in FIG. 1.

FIG. 1 illustrates positioning architecture 100 in a wireless communication system, according to some implementations. The wireless communication system includes a radio access network (RAN) and a core network (CN), each of which can include a plurality of entities. FIG. 1 illustrates the entities of the wireless communication system that are used for positioning of UEs served by the system. As shown in FIG. 1, the RAN can be a New Generation (NG) Radio Access Network (NG-RAN) 102. The CN can include an Access and Mobility Management Function (AMF) 104 and a Location Management Function (LMF) 106. The NG-RAN 102 can include a gNB 108 and/or an eNB 110. The gNB 108 can include one or more transmission/reception points (TRPs). A transmission/reception point is an antenna array that includes one or more antenna elements, and that is located at a specific geographic location to serve a specific area.

The positioning architecture 100 can be used for positioning UEs served by the system. As an example, the positioning architecture 100 can position a UE 112 served by the NG-RAN 102. In order to determine the location of the UE 112, the LMF 106 can request and receive location information from the UE 112. In particular, the NG-RAN 102 receives the location information from the UE 112 and provides the information to the LMF 106 via the AMF 104 over a next generation control plane interface (NG-C) 114. A new NR positioning protocol A (NRPPa) carries the location information over the NG-C 114. After using the location information to position the UE 112, the LMF 106 can use a Long Term Evolution (LTE) positioning protocol (LPP) to provide configuration information to the UE 112 via the AMF 104. For example, the configuration information can be provided to the AMF 104, which can then provide the information to the UE 112 via the NG-RAN 102 using radio resource control (RRC) signaling.

More recently, wireless communication systems have expanded their coverage by using UEs as relays. In particular, a relay UE can establish direct connections with other UEs, called remote UEs, in order to extend the coverage of a serving base station to those UEs. The UEs can be located in coverage of the base station or in partial coverage (e.g., some UEs are in coverage of the base station, and others are not). The connection that a relay UE establishes with one or more remote UEs is referred to as a sidelink connection (or simply sidelink). However, existing 3GPP telecommunication standards do not specify positioning techniques for remote UEs. Recently, 3GPP designated sidelink positioning as one of the topics for development in Release 18 (Rel-18) of the 3GPP telecommunication standards.

This disclosure describes systems and methods for sidelink positioning. The systems and methods can be applied in scenarios where a relay UE serves as a relay for a remote UE to a wireless communication system. The relay UE can be in-coverage of the system, and the remote UE can be in-coverage or out-of-coverage of the system. In one example, the relay UE is stationary, knows its absolute coordinates, and is capable of transmitting sidelink positioning reference signals (SL-PRS). In this example, the relay UE can function as a sidelink relay that relays positioning messages between the communication system and the remote UE. This functionality enables the communication system to position the remote UE, even if the remote UE is out-of-coverage. In order to implement this arrangement without altering the existing architecture of the core network (e.g., shown in FIG. 1), the communication system models the relay UE as a TRP of a base station that serves the relay UE. In particular, the base station presents the relay UE to the LMF as a TRP under the base station's control. Under this modeling, the base station can relay NRPPa messages (e.g., to obtain a sidelink PRS configuration) to/from the LMF via RRC to/from the remote UE.

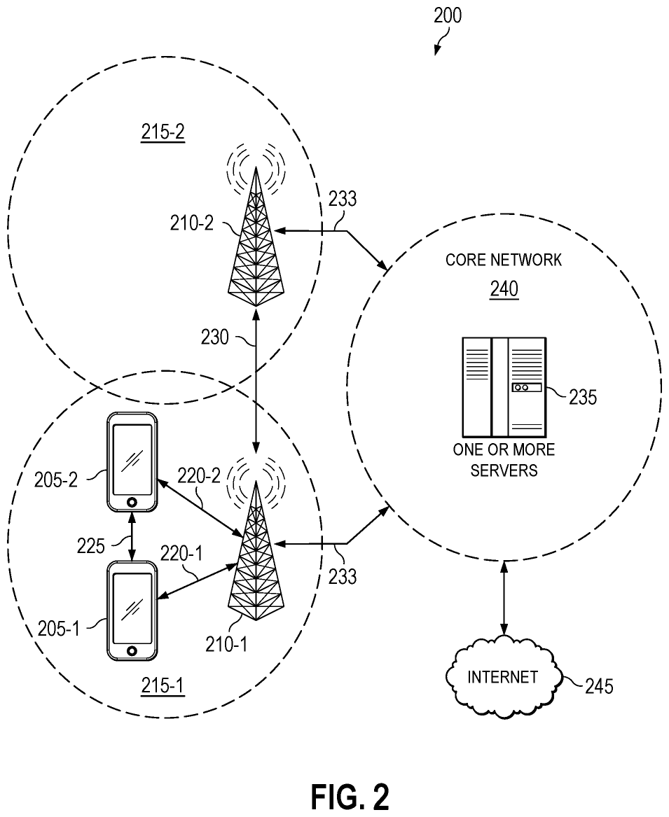

FIG. 2 illustrates an example communication system 200 that includes sidelink communications, according to some implementations. It is noted that the system of FIG. 2 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard, and the described examples may apply to other networks that may benefit from the principles described herein, such as 3GPP Long Term Evolution (LTE) networks, Wi-Fi, and the like. Furthermore, other types of communication standards are possible, including future 3GPP systems (e.g., Sixth Generation (6G)), or the like. While aspects may be described herein using terminology commonly associated with 5G NR, aspects of the present disclosure can be applied to other systems, such as 4G and/or systems subsequent to 5G (e.g., 6G).

As shown, the communication system 200 includes a number of user devices. More specifically, the communication system 200 includes two UEs 205 (UE 205-1 and UE 205-2 are collectively referred to as “UE 205” or “UEs 205”), two base stations 210 (base station 210-1 and base station 210-2 are collectively referred to as “base station 210” or “base stations 210”), two cells 215 (cell 215-1 and cell 215-2 are collectively referred to as “cell 215” or “cells 215”), and one or more servers 235 in a core network (CN) 240 that is connected to the Internet 245.

In some implementations, the UEs 205 can directly communicate with base stations 210 via links 220 (link 220-1 and link 220-2 are collectively referred to as “link 220” or “links 220”), which utilize a direct interface with the base stations referred to as a “Uu interface.” Each of the links 220 can represent one or more channels. The links 220 are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 210-1. In this example, UE 205-1 may conduct communications directly with UE 205-2. Similarly, the UE 205-2 may conduct communications directly with UE 205-1. Such peer-to-peer communications may utilize a “sidelink” interface such as a PC5 interface. In certain embodiments, the PC5 interface supports direct cellular communication between user devices (e.g., between UEs 205), while the Uu interface supports cellular communications with infrastructure devices such as base stations. For example, the UEs 205 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

To transmit/receive data to/from one or more base stations 210 or UEs 205, the UEs 205 may include a transmitter/receiver (or alternatively, a transceiver), memory, one or more processors, and/or other like components that enable the UEs 205 to operate in accordance with one or more wireless communications protocols and/or one or more cellular communications protocols. The UEs 205 may have multiple antenna elements that enable the UEs 205 to maintain multiple links 220 and/or sidelinks 125 to transmit/receive data to/from multiple base stations 210 and/or multiple UEs 205. For example, as shown in FIG. 2, UE 205-1 may connect with base station 210-1 via link 220-1 and simultaneously connect with UE 205-2 via sidelink 225. As also shown in FIG. 2, UE 205-2 may connect with base station 210-2 via link 220-2 and simultaneously connect with UE 205-1 via sidelink 225.

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 205 may be physical hardware devices capable of running one or more applications, capable of accessing network services via one or more radio links 120 with a corresponding base station 210 (also referred to as a “serving” base station), and capable of communicating with one another via sidelink 225. Link 220 may allow the UEs 205 to transmit and receive data from the base station 210 that provides the link 220. The sidelink 225 may allow the UEs 205 to transmit and receive data from one another. The sidelink 225 between the UEs 205 may include one or more channels for transmitting information from UE 205-1 to UE 205-2 and vice versa and/or between UEs 205 and UE-type RSUs and vice versa.

In some implementations, the base stations 210 are capable of communicating with one another over a backhaul connection 230 and may communicate with the one or more servers 235 within a core network (CN) 240 over another backhaul connection 233. The backhaul connections can be wired and/or wireless connections.

In some implementations, the UEs 205 are configured to use a resource pool for sidelink communications. A sidelink resource pool may be divided into multiple time slots, frequency channels, and frequency sub-channels. In some examples, the UEs 205 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, the communication system 200 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the communication system 200 is configured to perform sidelink positioning for a UE served by the communication system 200. Sidelink positioning can be performed in scenarios where one of the UEs (e.g., UE 205-1) is in-coverage of a serving base station (e.g., base station 210-1) and the other UE (e.g., UE 205-2) is in-coverage or out-of-coverage of the serving base station.

In some implementations, the in-coverage UE is configured to serve as a relay for the other UE (i.e., the remote UE). In these implementations, the relay UE is configured to support layer-2 (L2) sidelink relay functionality. This functionality enables the remote UE to transition to an RRC connected state with the base station even if the remote UE is out-of-overage. Additionally, this functionality allows the relay UE to serve as a sidelink relay that relays positioning messages between the communication system and the remote UE. Specifically, the remote UE can acquire system information from the base station via the relay UE. The system information includes a positioning system information block (posSIB), which includes positioning assistance data. Further, the functionality enables the remote UE to exchange LPP messages with the communication system via the relay UE. An LPP message can be encapsulated in a Non-Access-Stratum (NAS) message, which, in turn, is encapsulated in an RRC message. Furthermore, the relay UE is configured to transmit SL-PRS to the remote UE. In some examples, the relay UE can determine its absolute geographical coordinates. For instance, the relay UE can be a stationary UE, such as V2X roadside unit, that has fixed geographical coordinates.

In some implementations, the described configurations of the relay UE enable the relay UE to assist in positioning the remote UE. In particular, these configurations enable the relay UE to allow the communication system to communicate with the remote UE in order to position the remote UE. As an example, these configurations enable the relay UE to relay positioning messages between the communication system and the remote UE. As another example, these configurations enable the relay UE to transmit SL-PRS to the remote UE, which the remote UE can use to perform measurements that are used for positioning.

In some implementations, in order to allow the relay UE to perform the described functionalities without altering the existing architecture of the core network (e.g., shown in FIG. 1), the communication system models the relay UE as a TRP of the base station that is serving the relay UE. Specifically, the base station presents the relay UE to the core network (e.g., to the LMF) as a TRP under the base station's control. By modeling the relay UE as a TRP, the base station can relay positioning protocol messages to/from the LMF via RRC to/from the relay UE as the base station would do for other TRPs under the base station's control. The communication system may create a TRP type for UEs that can be modeled as TRPs. In one example, the TRP type is “SL TRP/UE.” In this disclosure, TRPs that are not “SL TRP/UE” TRPs are referred to as regular TRPs.

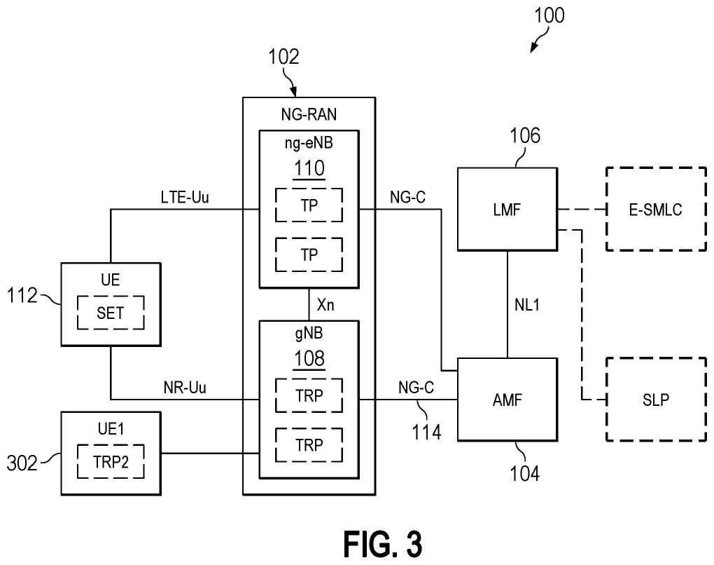

FIG. 3 illustrates an example of a relay user equipment (UE) integrated with the positioning architecture 100 of FIG. 1, according to some implementations. As shown in FIG. 3, the gNB 108 models the relay UE 302 as a second TRP controlled by the gNB 108. As such, the relay UE 302 is labeled as TRP2 and is assigned a TRP type “SL TRP/UE.” By modeling the relay UE 302 as a TRP, the communication system can position remote UEs coupled to the relay UE 302 using the existing positioning architecture 100.

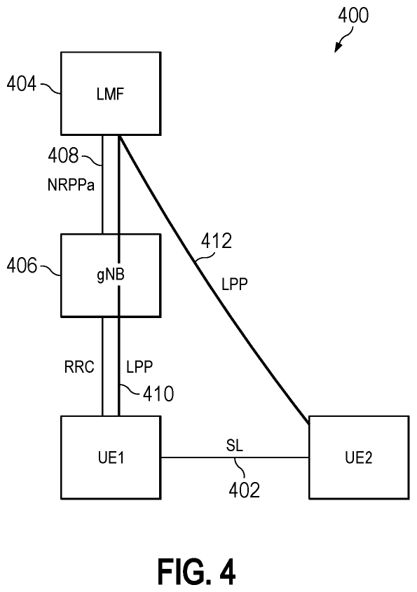

FIG. 4 illustrates example positioning protocols used in sidelink positioning, according to some implementations. As shown in FIG. 4, a relay UE, UE1, is configured to communicate with a remote UE, UE2, via a sidelink interface 402. Further, UE1 and UE2 are configured to communicate with an LMF 404 using an LPP protocol. More specifically, UE1 communicates with LMF 404 via gNB 406. This is shown in FIG. 4 as LPP link 410. Further, UE2 communicates with LMF 404 via UE1. This is shown in FIG. 4 as LPP link 412. Finally, gNB 406 communicates with LMF 404 using an NRPPa protocol, which is shown in FIG. 4 as NRPPa link 408.

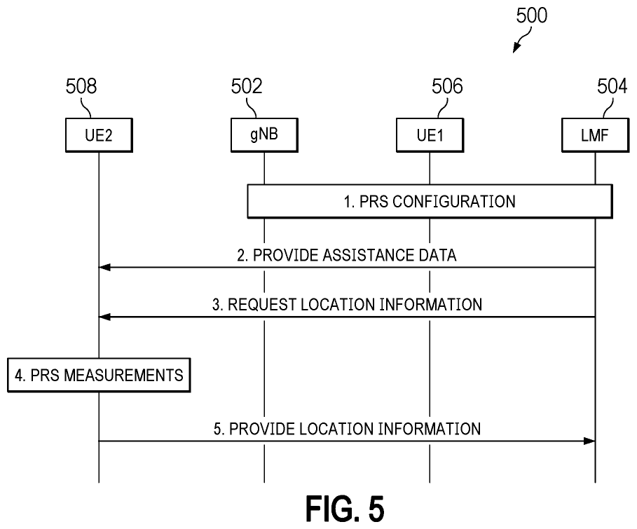

FIG. 5 illustrates an example communication flow 500 for positioning a UE in a communication network, according to some implementations. In this example, the communication network includes a gNB 502 and an LMF 504. The gNB 502 serves a relay UE1 (also labeled as UE 506). The relay UE1 can communicate via sidelink with a remote UE2 (also labeled as UE 508), which can be in-coverage or out-of-coverage of the gNB 502. In the example of FIG. 5, the relay UE1 is capable of transmitting SL PRS. As such, the relay UE1 can be modeled as a TRP of the gNB 502 and can be used for positioning UEs via sidelink.

At step 1, the LMF 504 requests PRS configuration information from the gNB 502. The LMF 504 uses NRPPa signaling to communicate the request to the gNB 502. In response to receiving the request, the gNB 502 obtains the PRS configuration information for any TRPs controlled by the gNB 502. In this example, because the gNB 502 models the relay UE1 as a TRP controlled by the gNB 502, the gNB 502 obtains PRS configuration information from the relay UE1 in addition to PRS configuration information from regular TRPs. The gNB 502 then provides the PRS configuration information to the LMF 504. In an example, the PRS configuration information includes timing and configuration information for PRS transmissions. Additionally and/or alternatively, the PRS configuration information includes location coordinates of the gNB 502 and/or the TRPs controlled by the gNB 502 (including the relay UE1). As described below, the LMF 504 can later provide some or all of this information to the UE as assistance data.

In some implementations, the LMF 504 uses an NRPPa message called “TRP INFORMATION REQUEST” to request the PRS configuration information from the gNB 502. In the NRPPa message, the LMF 504 can request information about all TRPs controlled by the gNB 502 or can request information about a specific TRP type, e.g., “SL TRP/UE.” When the gNB 502 receives the NRPPa message, the gNB 502 determines that the LMF 504 is requesting information about SL TRP/UE type TRPs. In response to the determination, the gNB 502 triggers an RRC message to the SL TRP/UE type TRPs. In this example, the gNB 502 triggers an RRC message to the relay UE1. The RRC message can include a “SL PRS Information Request” information element (IE). In the IE, the gNB 502 can relay the relevant parts of the received NRPPa message. In one example, the RRC message is a “DLInformationTransfer” message.

In some implementations, the relay UE1 (and other PRS capable relay UEs) generates a response message in response to receiving the RRC message from the gNB 502. The response message can include the information requested by the gNB 502, perhaps in an “SL PRS Information” IE. In one example, the response message is an RRC “ULInformationTransfer” message. The relay UE1 then transmits the response message to the gNB 502.

In some implementations, after receiving the response from the relay UE1, the gNB 502 generates a response message to the LMF 504. The response message includes information about the TRPs that are controlled by the gNB 502 and the information received from the TRPs. In some examples, the information received from the relay UE1 (e.g., SL configuration information) may be carried in a separate IE from the information received from other TRPs. The separate IE may be specific for the “SL TRP/UE” TRP type. The IE can include a TRP type field, an SL PRS configuration field (e.g., similar to the field in § 9.2.44 of 3GPP TS 38.455 V16.7.0), and/or a geographical coordinates field. The response message to the LMF 504 may be a “NRPPA TRP INFORMATION RESPONSE” message.

As shown in step 2, the LMF 504 can provide some or all of the information received from the gNB 502 to the remote UE2 as assistance data in an LPP message. In addition to the legacy DL PRS information of legacy TRPs, the LPP message includes SL PRS configuration information (e.g., from the relay UE1) and/or geographical coordinates of the relay UEs (e.g., relay UE1). The LPP message that carries the assistance data may be a “ProvideAssistanceData” message.

At step 3, the LMF 504 requests location information from the remote UE2 using an LPP message, perhaps a “RequestLocationInformation” message. In response to receiving the LPP message, and as shown by step 4, the remote UE2 uses the PRS configuration information received in the assistance data to perform measurements of PRS, including an SL PRS transmitted by the relay UE1. In some examples, the remote UE2 performs the measurements prior to receiving the LPP message requesting location information.

At step 5, the remote UE2 provides the LMF 504 with the location information carried in an LPP message, perhaps a “ProvideLocationInformation” message. The location information includes measurements (e.g., RSRP, RSRQ, or RSSI) of DL PRS of regular TRPs and measurements of SL PRS.

In some implementations, SL PRS can also be used for UL positioning enhancements. In these implementations, a relay UE can perform measurements on SL PRS/SRS transmitted by a remote UE on a sidelink channel. The relay UE can provide the measurements to an LMF. The LMF can use these measurements and UL PRS/SRS measurements performed by regular TRPs for UL positioning. There are two signaling options for the relay UE to provide the measurements to the LMF. In the first option, the LMF controls the relay UE to perform the measurement and report on the remote UE's position directly via LPP. In the second option, the LMF asks the gNB to report the remote UE's location. In turn, the gNB asks the relay UE to perform the measurement and report the remote UE's location. The gNB can provide the location report to LMF based on the relay UE's location together with the remote UE's location via NRPPa.

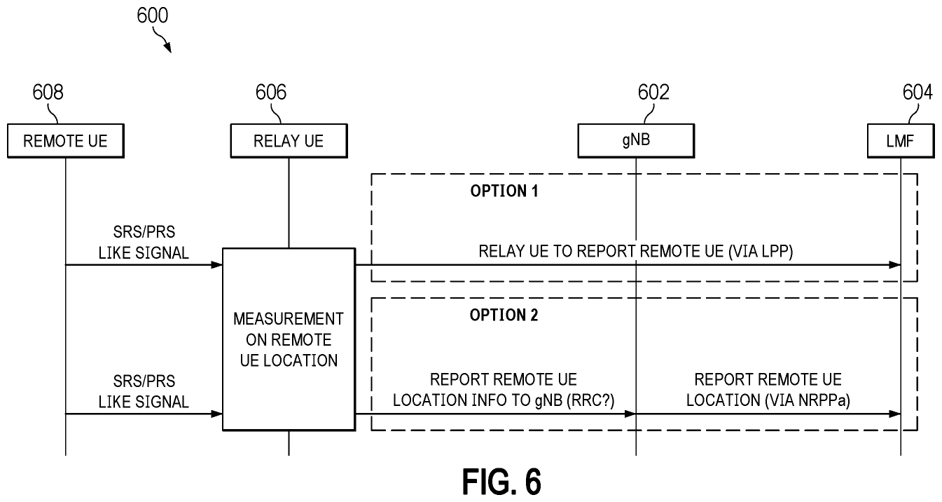

FIG. 6 illustrates an example uplink sidelink positioning workflow 600, according to some embodiments. As shown in FIG. 6, a remote UE 608 transmits SRS or PRS like signals on a sidelink channel with a relay UE 606. The relay UE 606 receives the signals and performs a measurement on the signals (e.g., RSRP, RSRQ, or RSSI). The relay UE 606 has two options for reporting the measurement to the core network. In the first option, Option 1, the relay UE 606 directly reports the measurement to an LMF 604 using LPP signaling. In the second option, Option 2, the relay UE 606 reports the measurement to a serving gNB 602 using RRC signaling. The gNB 602 then reports the measurement to the LMF 604 using NRPPa signaling.

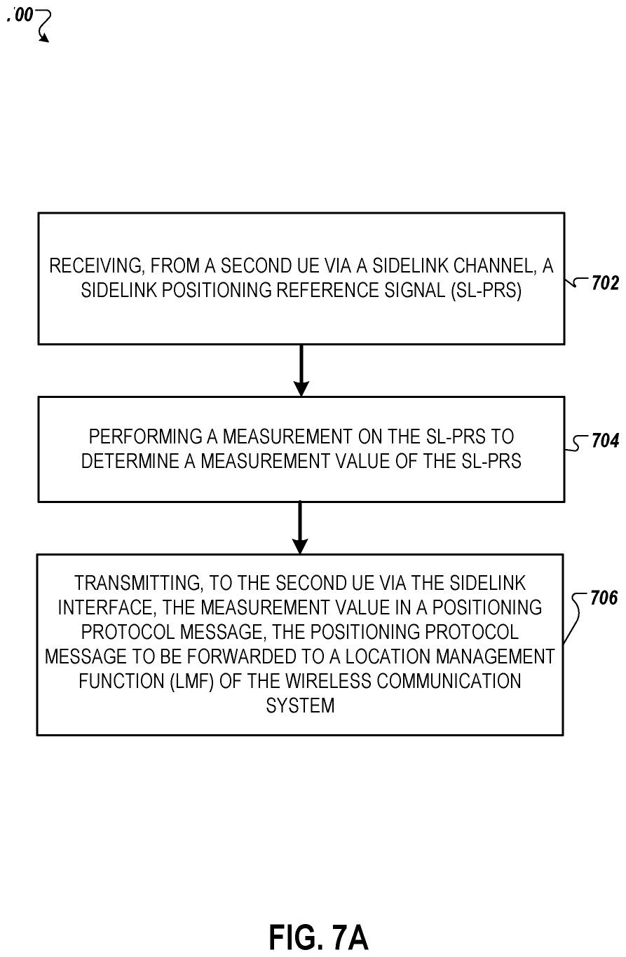

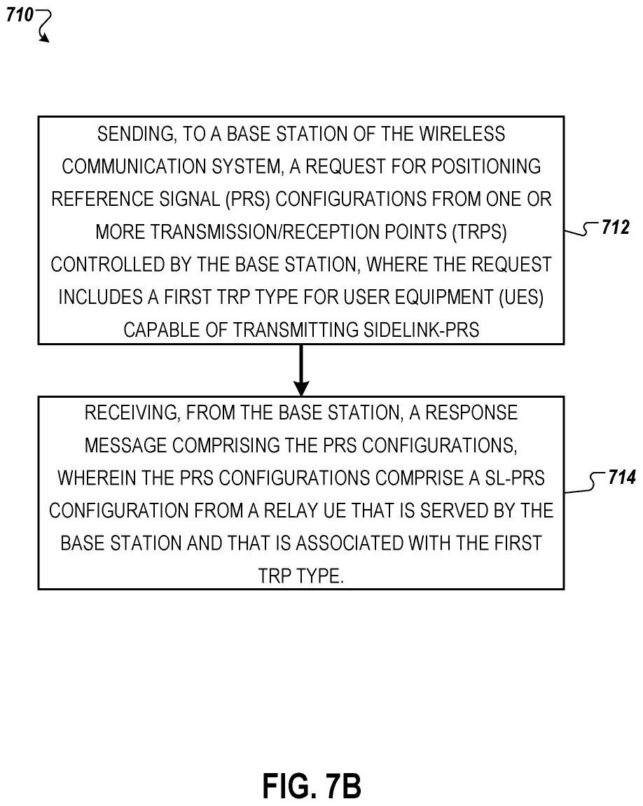

FIG. 7A illustrates a flowchart of an example method 700, according to some implementations. For clarity of presentation, the description that follows generally describes method 700 in the context of the other figures in this description. For example, method 700 can be performed by a first UE in a wireless communication system (e.g., UE 205-1 of FIG. 2). It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

At 702, method 700 involves receiving, from a second UE via a sidelink channel, a sidelink positioning reference signal (SL-PRS).

At 704, method 700 involves performing a measurement on the SL-PRS to determine a measurement value of the SL-PRS.

At 708, method 700 involves transmitting, to the second UE via the sidelink interface, the measurement value in a positioning protocol message, the positioning protocol message to be forwarded to a Location Management Function (LMF) of the wireless communication system.

In some implementations, method 700 further involves: receiving, from the second UE via the sidelink channel, assistance information including configuration information of the SL-PRS.

In some implementations, the positioning protocol message is a first positioning protocol message, and the assistance information is received in a second positioning protocol message from the LMF.

In some implementations, the assistance information further includes geographical coordinates of the second UE.

In some implementations, the second UE is served by a base station, and the assistance information further includes configuration information of positioning reference signals transmitted by the base station.

In some implementations, method 700 further involves: receiving, from the second UE via the sidelink channel, a request for location information of the first UE.

In some implementations, the positioning protocol message is a first positioning protocol message, and the request for location information is received in a second positioning protocol message from the LMF.

In some implementations, the SL-PRS is a downlink SL-PRS, and method 700 further involves: transmitting, via the sidelink channel, an uplink SL-PRS to the second UE.

In some implementations, the second UE is assigned a transmission/reception point (TRP) type.

In some implementations, the positioning protocol is a Long Term Evolution (LTE) positioning protocol (LPP).

FIG. 7B illustrates a flowchart of an example method 710, according to some implementations. For clarity of presentation, the description that follows generally describes method 710 in the context of the other figures in this description. For example, method 710 can be performed by an LMF (e.g., LMF 106 of FIG. 1). It will be understood that method 710 can be performed, for example, by any suitable system, environment, software, hardware, or a combination of systems, environments, software, and hardware, as appropriate. In some implementations, various steps of method 710 can be run in parallel, in combination, in loops, or in any order.

At 712, method 710 involves sending, to a base station of the wireless communication system, a request for positioning reference signal (PRS) configurations from one or more transmission/reception points (TRPs) controlled by the base station, where the request includes a first TRP type for user equipment (UEs) capable of transmitting sidelink-PRS (SL-PRS).

At 714, method 710 involves receiving, from the base station, a response message including the PRS configurations. The PRS configurations include an SL-PRS configuration from a relay UE that is served by the base station and that is associated with the first TRP type.

In some implementations, the request and the response message are positioning protocol signaling.

In some implementations, method 710 further involves: generating a message to provide assistance data to a remote UE coupled to the relay UE via a sidelink channel, where the assistance data includes at least the SL-PRS configuration.

In some implementations, the assistance information further includes geographical coordinates of the relay UE.

In some implementations, method 710 further involves: generating a request for location information to be transmitted to a remote UE coupled to the relay UE via a sidelink channel.

In some implementations, method 710 further involves: receiving, from the remote UE, the location information of the remote UE, where the location information includes a measurement of the SL-PRS.

In some implementations, the SL-PRS is downlink SL-PRS, and method 710 further involves: sending instructions to the relay UE to receive uplink SL-PRS from the remote UE; and receiving, from the relay UE, a measurement of the uplink SL-PRS.

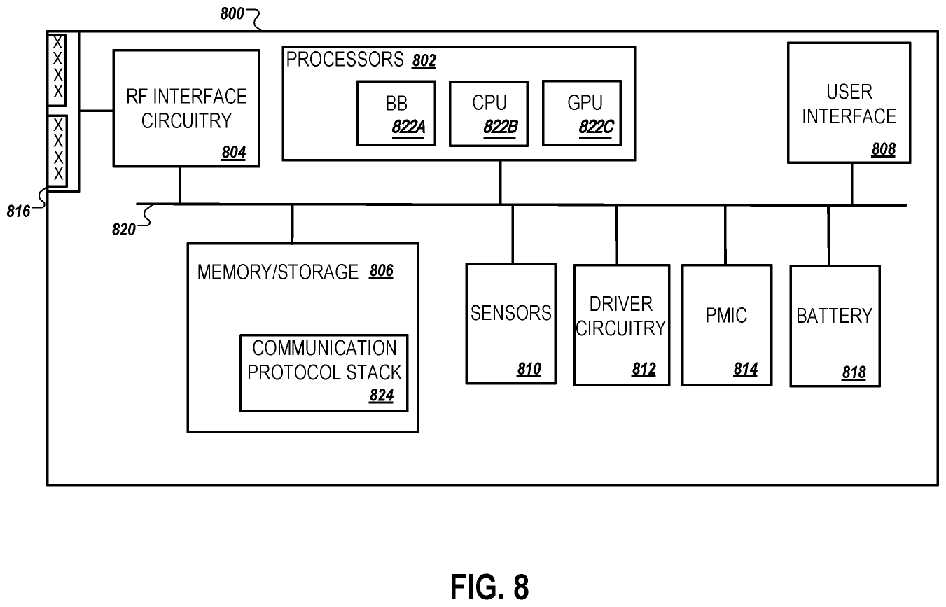

FIG. 8 illustrates a UE 800, according to some implementations. The UE 800 may be similar to and substantially interchangeable with UE 205 of FIG. 2.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smartwatch), relaxed-IoT devices.

The UE 800 may include processors 802, RF interface circuitry 804, memory/storage 806, user interface 808, sensors 810, driver circuitry 812, power management integrated circuit (PMIC) 814, one or more antennas 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

In some implementations, the processors 802 are configured to cause the UE to receive, from another UE via a sidelink channel, a sidelink positioning reference signal (SL-PRS). The processors 802 are further configured to cause the UE to perform a measurement on the SL-PRS to determine a measurement value of the SL-PRS. Yet further, the processors 802 are configured to cause the UE to transmit, to another UE via the sidelink interface, the measurement value in a positioning protocol message, the positioning protocol message to be forwarded to a Location Management Function (LMF) of the wireless communication system.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 816. In various implementations, the RF interface circuitry 804 may be configured to transmit/receive signals in a manner compatible with NR access technologies.

The antenna 816 may include antenna elements to convert electrical signals into radio waves to travel through the air and convert received radio waves into electrical signals. The antenna elements may be arranged into one or more antenna panels. The antenna 816 may have antenna panels that are omnidirectional, directional, or a combination thereof to enable beamforming and multiple input, multiple output communications. The antenna 816 may include microstrip antennas, printed antennas fabricated on the surface of one or more printed circuit boards, patch antennas, phased array antennas, etc. The antenna 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium-ion battery, a metal-air battery, such as a zinc-air battery, an aluminum-air battery, a lithium-air battery, and the like. In some implementations, such as in vehicle-based applications, the battery 818 may be a typical lead-acid automotive battery.

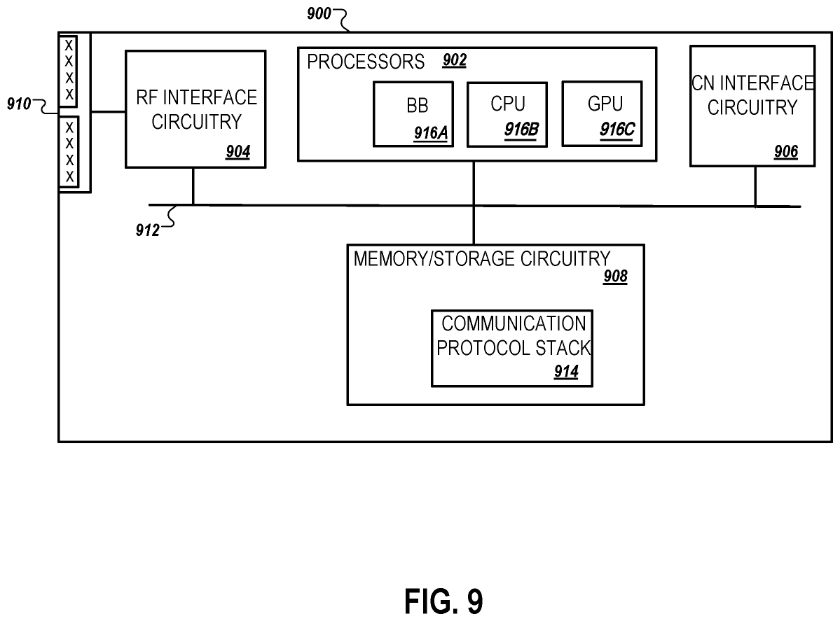

FIG. 9 illustrates an access node 900 (e.g., a base station or gNB), according to some implementations. The access node 900 may be similar to and substantially interchangeable with base station 210 of FIG. 2. The access node 900 may include processors 902, RF interface circuitry 904, core network (CN) interface circuitry 906, memory/storage circuitry 908, and one or more antennas 910.

The components of the access node 900 may be coupled with various other components over one or more interconnects 912. The processors 902, RF interface circuitry 904, memory/storage circuitry 908 (including communication protocol stack 914), one or more antennas 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells, or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

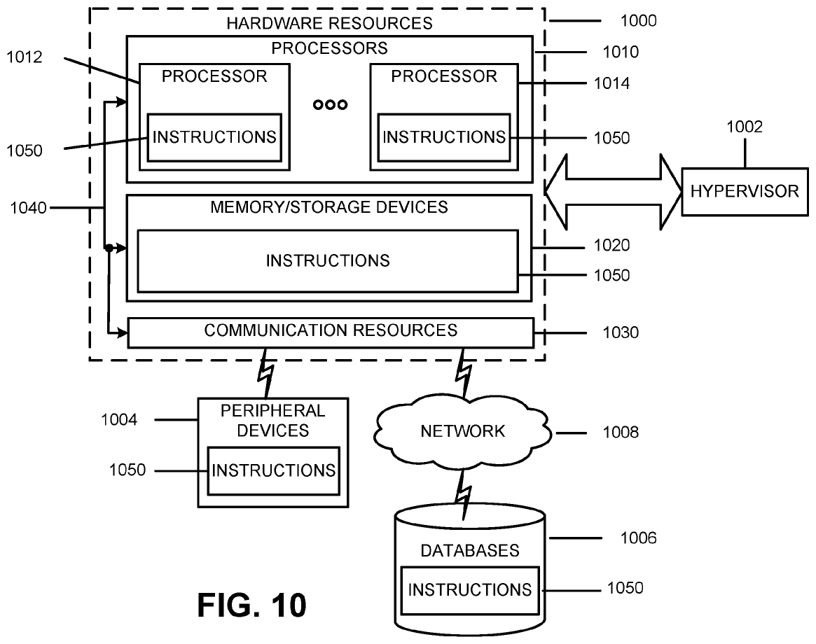

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. For example, an LMF can be implemented using the components in FIG. 10. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., Network functions virtualization) is utilized, a hypervisor 1002 may be executed to provide an execution environment for one or more network slices/sub-slices to utilize the hardware resources 1000.

The processors 1010 may include, for example, a processor 1012 and a processor 1014. The processor(s) 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

In some implementations, the processors 1010 are configured to cause an LMF to send, to a base station of a wireless communication system, a request for positioning reference signal (PRS) configurations from one or more transmission/reception points (TRPs) controlled by the base station, where the request includes a first TRP type for user equipment (UEs) capable of transmitting sidelink-PRS (SL-PRS). Additionally, the processors 1010 are configured to cause an LMF to receive, from a base station, a response message including the PRS configurations, where the PRS configurations include an SL-PRS configuration from a relay UE that is served by the base station and that is associated with the first TRP type.

The memory/storage devices 1020 may include main memory, disk storage, or any suitable combination thereof. The memory/storage devices 1020 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via USB), cellular communication components, NFC components, Bluetooth® (or Bluetooth® Low Energy) components, Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more embodiments, at least one of the components set forth in one or more of the preceding figures may be configured to perform one or more operations, techniques, processes, or methods as set forth in the example section below. For example, the baseband circuitry, as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

### EXAMPLES

Example 1 includes one or more processors of a first user equipment (UE) in a wireless communication system, the one or more processors configured to perform operations including: receiving, from a second UE via a sidelink channel, a sidelink positioning reference signal (SL-PRS); performing a measurement on the SL-PRS to determine a measurement value of the SL-PRS; and transmitting, to the second UE via the sidelink interface, the measurement value in a positioning protocol message, the positioning protocol message to be forwarded to a Location Management Function (LMF) of the wireless communication system.

Example 2 is the one or more processors of Example 1, the operations further including: receiving, from the second UE via the sidelink channel, assistance information including configuration information of the SL-PRS.

Example 3 is the one or more processors of Example 2, wherein the positioning protocol message is a first positioning protocol message, and wherein the assistance information is received in a second positioning protocol message from the LMF.

Example 4 is the one or more processors of Example 2, wherein the assistance information further includes geographical coordinates of the second UE.

Example 5 is the one or more processors of Example 2, wherein the second UE is served by a base station, and wherein the assistance information further includes configuration information of positioning reference signals transmitted by the base station.

Example 6 is the one or more processors of any of Examples 1-5, the operations further including: receiving, from the second UE via the sidelink channel, a request for location information of the first UE.

Example 7 is the one or more processors of Example 6, wherein the positioning protocol message is a first positioning protocol message, and wherein the request for location information is received in a second positioning protocol message from the LMF.

Example 8 is the one or more processors of any of Examples 1-7, wherein the SL-PRS is a downlink SL-PRS, and the operations further including: transmitting, via the sidelink channel, an uplink SL-PRS to the second UE.

Example 9 is the one or more processors of any of Examples 1-8, wherein the second UE is assigned a transmission/reception point (TRP) type.

Example 10 is the one or more processors of any of Examples 1-9, wherein the positioning protocol is a Long Term Evolution (LTE) positioning protocol (LPP).

Example 11 is the one or more processors of a core network device in a wireless communication system, the one or more processors configured to perform operations including: sending, to a base station of the wireless communication system, a request for positioning reference signal (PRS) configurations from one or more transmission/reception points (TRPs) controlled by the base station, wherein the request includes a first TRP type for user equipment (UEs) capable of transmitting sidelink-PRS (SL-PRS); and receiving, from the base station, a response message including the PRS configurations, wherein the PRS configurations include an SL-PRS configuration from a relay UE that is served by the base station and that is associated with the first TRP type.

Example 12 is the one or more processors of Example 11, wherein the request and the response message are positioning protocol signaling.

Example 13 is the one or more processors of any of Examples 11-12, the operations further including generating a message to provide assistance data to a remote UE coupled to the relay UE via a sidelink channel, wherein the assistance data includes at least the SL-PRS configuration.

Example 14 is the one or more processors of Example 13, wherein the assistance data further includes geographical coordinates of the relay UE.

Example 15 is the one or more processors of any of Examples 11-14, the operations further including: generating a request for location information to be transmitted to a remote UE coupled to the relay UE via a sidelink channel.

Example 16 is the one or more processors of Example 15, the operations further including: receiving, from the remote UE, the location information of the remote UE, wherein the location information includes a measurement of the SL-PRS.

Example 17 is the one or more processors of any of Examples 11-16, wherein the SL-PRS is downlink SL-PRS, and the operations further including: sending instructions to the relay UE to receive uplink SL-PRS from a remote UE; and receiving, from the relay UE, a measurement of the uplink SL-PRS.

Example 18 may include a non-transitory computer storage medium encoded with instructions that, when executed by one or more computers, cause the one or more computers to perform the operations of any of Examples 1 to 17.

Example 19 may include a system including one or more computers and one or more storage devices on which are stored instructions that are operable, when executed by the one or more computers, to cause the one or more computers to perform the operations of any of Examples 1 to 17.

Example 20 may include a method for performing the operations of any of Examples 1 to 17.

Example 21 may include an apparatus including logic, modules, or circuitry to perform one or more elements of the operations described in or related to any of Examples 1-17, or any other operations or process described herein.

Example 22 may include a method, technique, or process as described in or related to the operations of any of Examples 1-17, or portions or parts thereof.

Example 23 may include an apparatus, e.g., a user equipment, including: one or more processors and one or more computer-readable media including instructions that, when executed by the one or more processors, cause the one or more processors to perform the method, techniques, or process as described in or related to the operations of any of Examples 1-10, or portions thereof.

Example 24 may include an apparatus, e.g., a core network device implementing an LMF, including: one or more processors and one or more computer-readable media including instructions that, when executed by the one or more processors, cause the one or more processors to perform the method, techniques, or process as described in or related to the operations of any of Examples 11-17, or portions thereof.

Example 25 may include a signal as described in or related to any of Examples 1-17, or portions or parts thereof.

Example 26 may include a datagram, information element (IE), packet, frame, segment, PDU, or message as described in or related to any of Examples 1-17, or portions or parts thereof, or otherwise described in the present disclosure.

Example 27 may include a signal encoded with data as described in or related to any of examples 1-17, or portions or parts thereof, or otherwise described in the present disclosure.

Example 28 may include a signal encoded with a datagram, IE, packet, frame, segment, PDU, or message as described in or related to any of Examples 1-17, or portions or parts thereof, or otherwise described in the present disclosure.

Example 29 may include an electromagnetic signal carrying computer-readable instructions, wherein execution of the computer-readable instructions by one or more processors is to cause the one or more processors to perform the method, techniques, or process as described in or related to the operations of any of Examples 1-17, or portions thereof.

Example 30 may include a computer program including instructions, wherein execution of the program by a processing element is to cause the processing element to carry out the method, techniques, or process as described in or related to the operations of any of Examples 1-17, or portions thereof. The operations or actions performed by the instructions executed by the processing element can include the operations of any one of Examples 1-17.

Example 31 may include a signal in a wireless network as shown and described herein.

Example 32 may include a method of communicating in a wireless network as shown and described herein.

Example 33 may include a system for providing wireless communication as shown and described herein. The operations or actions performed by the system can include the operations of any one of Examples 1-17.

Example 34 may include a device for providing wireless communication as shown and described herein. The operations or actions performed by the device can include the operations of any one of Examples 1-17.

The previously-described operations of Examples 1-17 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors of a first user equipment (UE) in a wireless communication system, the one or more processors configured to cause the first UE to perform operations comprising:
receiving, from a second UE via a sidelink channel, a sidelink positioning reference signal (SL-PRS);
performing a measurement on the SL-PRS to determine a measurement value of the SL-PRS; and
transmitting, to the second UE via a sidelink interface, the measurement value in a positioning protocol message.

2. The one or more processors of claim 1, the operations further comprising:
receiving, from the second UE via the sidelink channel, assistance information comprising configuration information of the SL-PRS.

3. The one or more processors of claim 2, wherein the positioning protocol message is a first positioning protocol message, and wherein the assistance information is received in a second positioning protocol message from a Location Management Function (LMF).

4. The one or more processors of claim 2, wherein the assistance information further comprises geographical coordinates of the second UE.

5. The one or more processors of claim 2, wherein the second UE is served by a base station, and wherein the assistance information further comprises configuration information of positioning reference signals transmitted by the base station.

6. The one or more processors of claim 1, the operations further comprising:
receiving, from the second UE via the sidelink channel, a request for location information of the first UE.

7. The one or more processors of claim 6, wherein the positioning protocol message is a first positioning protocol message, and wherein the request for location information is received in a second positioning protocol message from a Location Management Function (LMF).

8. The one or more processors of claim 1, wherein the SL-PRS is a downlink SL-PRS, and the operations further comprising:
transmitting, via the sidelink channel, an uplink SL-PRS to the second UE.

9. The one or more processors of claim 1, any wherein the second UE is assigned a transmission/reception point (TRP) type.

10. The one or more processors of claim 1, wherein the positioning protocol message is a Long Term Evolution (LTE) positioning protocol (LPP) message.

11. One or more processors of a core network device in a wireless communication system, the one or more processors configured to perform operations comprising:
sending, to a base station of the wireless communication system, a request for positioning reference signal (PRS) configurations from one or more transmission/reception points (TRPs) controlled by the base station, wherein the request comprises a first TRP type for user equipment (UEs) capable of transmitting sidelink-PRS (SL-PRS); and
receiving, from the base station, a response message comprising the PRS configurations, wherein the PRS configurations comprise an SL-PRS configuration from a relay UE that is served by the base station and that is associated with the first TRP type.

12. The one or more processors of claim 11, wherein the request and the response message are positioning protocol signaling.

13. The one or more processors of claim 11, the operations further comprising:
generating a message to provide assistance data to a remote UE coupled to the relay UE via a sidelink channel, wherein the assistance data comprises at least the SL-PRS configuration.

14. The one or more processors of claim 13, wherein the assistance data further comprises geographical coordinates of the relay UE.

15. The one or more processors of claim 11, the operations further comprising:
generating a request for location information to be transmitted to a remote UE coupled to the relay UE via a sidelink channel.

16. The one or more processors of claim 15, the operations further comprising:
receiving, from the remote UE, the location information of the remote UE, wherein the location information comprises a measurement of the SL-PRS.

17. The one or more processors of claim 11, wherein the SL-PRS is downlink SL-PRS, and the operations further comprising:
sending instructions to the relay UE to receive uplink SL-PRS from a remote UE; and
receiving, from the relay UE, a measurement of the uplink SL-PRS.

18. (canceled)

19. A user equipment (UE) comprising one or more processors that are configured to perform the operations of claim 1.

20. A core network device comprising one or more processors that are configured to perform the operations of claim 11.

21. A method for performing operations comprising:
receiving, from a second UE via a sidelink channel, a sidelink positioning reference signal (SL-PRS);
performing a measurement on the SL-PRS to determine a measurement value of the SL-PRS; and
transmitting, to the second UE via a sidelink interface, the measurement value in a positioning protocol message.
